(19) United States
(12) Patent Application Publication
(10) Pub. No.: US 2026/0155346 A1
(43) Pub. Date: Jun. 4, 2026

(54) METHOD OF MANUFACTURING ELECTRODE ACTIVE MATERIAL SHEET

(71) Applicant: TOYOTA JIDOSHA KABUSHIKI KAISHA, Toyota-shi (JP)

(72) Inventors: Jun IZUMI, Toyota-shi (JP); Satoshi NAKASHIMA, Toyota-shi (JP); Masashi UEDA, Toyota-shi (JP); Atsushi SUGIHARA, Toyota-shi (JP)

(73) Assignee: TOYOTA JIDOSHA KABUSHIKI KAISHA, Toyota-shi (JP)

(21) Appl. No.: 19/288,144

(22) Filed: Aug. 1, 2025

(30) Foreign Application Priority Data
Dec. 4, 2024 (JP) 2024-211792

(51) Int. Cl. H01M 4/04; H01M 4/62

(52) U.S. Cl. CPC H01M 4/0435; H01M 4/623

(57) ABSTRACT

A method of the present disclosure for producing an electrode active material sheet includes providing an electrode mixture comprising active material particles, a binder, and ethylene carbonate, and pressing the electrode mixture with a press member, wherein pressing the electrode mixture with the press member includes at least partially melting the ethylene carbonate.

### CROSS-REFERENCE TO RELATED APPLICATION

This application claims priority to Japanese Patent Application No. 2024-211792 filed on Dec. 4, 2024. The disclosure of the above-identified application, including the specification, drawings, and claims, is incorporated by reference herein in its entirety.

### BACKGROUND

### 1. Technical Field

The present disclosure relates to a method of manufacturing an electrode active material sheet.

### 2. Description of Related Art

An electrode active material sheet is obtained by forming an electrode mixture into a sheet by rolling or the like, and is used for an active material layer of an electrode.

For example, WO 2022/163186 discloses an electrode including a core material and an electrode mixture laminated on the surface of the core material. The electrode mixture includes an active material and polytetrafluoroethylene (PTFE). In an image illustrating the composition distribution obtained when the surface of the electrode mixture is measured using energy-dispersive X-ray analysis, the standard deviation of the area ratio of the PTFE in 30 adjacent sections having a size of 150 μm by 133 μm is 6% or less. When the electrode mixture is divided in the thickness direction into three equal parts defined as a first region, a second region, and a third region from the core material side, the content (a) of the PTFE in the first region, the content (b) of the PTFE in the second region, and the content (c) of the PTFE in the third region satisfy (c−a)/(a+b+c)≤±10%. According to the electrode described in WO 2022/163186, it is considered that the tensile strength can be improved.

WO 2023/008803 discloses a secondary battery electrode including a dry electrode film made of an active material, a conductive material, and a fibrillated binder having an average particle size of 0.05 μm to 3 μm, and a current collector on which the electrode film is laminated. The secondary battery electrode described in WO 2023/008803 is considered to be a secondary battery electrode including a dry electrode film that includes an active material having a small particle size but is excellent in flexibility and minimizes bending.

### SUMMARY

In the dry film formation using rolling, it is necessary to roll the electrode mixture in a state with high solid concentration. During this rolling, the friction between the particles constituting the electrode mixture is large. Thus, in the rolling, it is necessary to use a press device having a large output, such as a large roll press (to increase the pressure to be provided), a plurality of roll presses (to increase the number of times to provide pressure), and the like, for example. There is a possibility of increasing the device size and the investment cost.

Further, while the friction between the particles can be suppressed by a commonly used lubricant, it is necessary to dry the lubricant. Therefore, it is difficult to implement a film forming method without a drying process, that is, as a dry film forming method.

An object of the present disclosure is to reduce friction between particles during dry film formation of active material particles.

The present disclosure achieves the above object by the following measures.

### First Aspect

A method of manufacturing an electrode active material sheet, the method including:
(a) providing an electrode mixture comprising active material particles, a binder, and ethylene carbonate; and
(b) pressing the electrode mixture using a press member, in which the pressing of the electrode mixture using the press member in (b) includes at least partially melting the ethylene carbonate.

### Second Aspect

The method according to the first aspect, in which a temperature of the press member is equal to or higher than a melting point of the ethylene carbonate.

### Third Aspect

The method according to the first or second aspect, in which the binder is polytetrafluoroethylene.

### Fourth Aspect

The method according to any one of the first to third aspects, in which the press member is a press roll.

According to the above method, it is possible to reduce friction between particles during rolling of active material particles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram for explaining step (a); and

FIG. 2 is a schematic diagram for explaining step (b).

### DETAILED DESCRIPTION OF EMBODIMENTS

### Method for Manufacturing Electrode Active Material Sheet

A method of manufacturing an electrode active material sheet according to the present disclosure includes:
(a) Providing an electrode mixture comprising active material particles, a binder, and ethylene carbonate, and
(b) Pressing the electrode mixture with a press member,
The method further includes the following steps that are performed when removing the storage battery from the storage battery storage equipment:
Pressing the electrode mixture with the press member in step (b) includes at least partially melting the ethylene carbonate.

According to the above method, it is possible to reduce friction between the particles during rolling of the active material particles.

In the dry film formation using rolling, it is necessary to roll the electrode mixture in a state of high solid concentration. In the rolling, since the friction between the particles constituting the electrode mixture is large, it is necessary to use a press device having a large output. For example, in this rolling, the use of a large roll press (for increasing the pressure to be provided) or a plurality of roll presses (for increasing the number of times to provide pressure) is necessary, and there is a concern about an increase in the size of the apparatus and an increase in investment.

On the other hand, according to the present disclosure, ethylene carbonate in the electrode mixture is used as a lubricant by using an electrode mixture containing ethylene carbonate and rolling the electrode mixture in a state where ethylene carbonate is melted. Thereby, the load during rolling can be reduced, and the above problem can be solved.

Ethylene carbonate is in a solid state at room temperature (25° C.) and is an electrolyte component. Since it is unnecessary to dry and remove the ethylene carbonate after the film formation, the method of the present disclosure can be used even when the entire film formation process is performed as a dry film formation.

Hereinafter, embodiments of the present disclosure will be described in detail. Note that the present disclosure is not limited to the following embodiments, and various modifications can be made within the scope of the gist of the present disclosure. In the description of the drawings, the same elements are denoted by the same reference numerals, and redundant description will be omitted.

### Process (a)

The method of the present disclosure for producing an electrode active material sheet first provides an electrode mixture comprising active material particles, a binder, and ethylene carbonate.

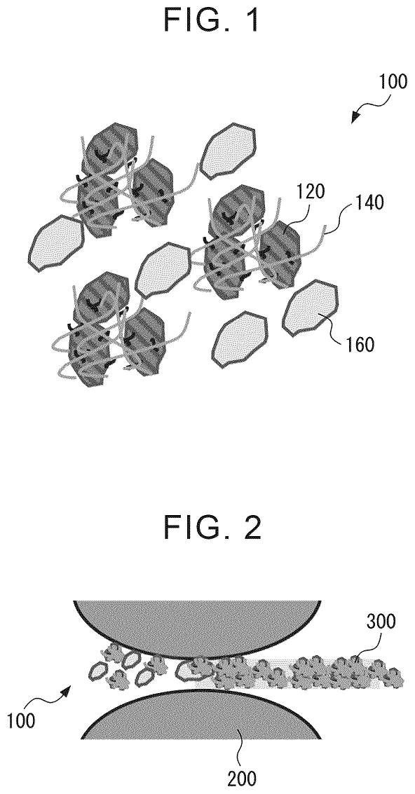

FIG. 1 illustrates one embodiment of the present disclosure, but is not limited thereto. The electrode mixture 100 contains active material particles 120, a binder 140, and ethylene carbonate 160. The binder 140 is fibrillated by pre-shearing the active material particles 120 and the binder 140, and then ethylene carbonate is added thereto. As a result, as shown in FIG. 1, an electrode mixture containing active material particles, a binder entangled with the active material particles, and ethylene carbonate can be obtained.

### Electrode Mixture

In the present disclosure, the electrode mixture includes at least active material particles, a binder, and ethylene carbonate, and can be obtained, for example, by adding and mixing ethylene carbonate to a shear mixture of the active material particles and the binder. The electrode mixture may further contain a carbon nanotube (CNT) or the like as a conductive aid.

### Active Material Particles

In the present disclosure, the active material particles are included in the electrode mixture. In the context of the present disclosure, the “active material particles” may be “positive electrode active material particles” or “negative electrode active material particles”.

The content of the active material particles in the electrode mixture of the present disclosure is not particularly limited, but may be 1% by mass or more, 5% by mass or more, 10% by mass or more, 15% by mass or more, or 20% by mass or more, and may be 50% by mass or less, 45% by mass or less, 40% by mass or less, 35% by mass or less, or 30% by mass or less.

The material of the positive electrode active material particles is not particularly limited. For example, the positive electrode active material particles may be, but are not limited to, lithium cobaltate (LiCoO₂), lithium nickelate (LiNiO₂), lithium manganate (LiMn₂O₄), lithium nickel cobalt manganate (NCM: LiCO_{1/3}Ni_{1/3}Mn_{1/3}O₂), lithium nickel cobalt aluminum (LiNi_{0.8}(CoAl)_{0.2}O₂), and heteroatom-substituted Li—Mn spinel of a composition represented by Li₁₊ₓMn_{2-x-y}M_{y}O₄ (M is one or more metallic elements selected from Al, Mg, Co, Fe, Ni, and Zn), for example.

The positive electrode active material particles may have any shape, and may be, for example, spherical, ellipsoidal, flake-like, or fibrous.

The particle diameter D₅₀ of the positive electrode active material particles may be, for example, equal to or greater than 1 nm, equal to or greater than 5 nm, or equal to or greater than 10 nm, and may be equal to or less than 500 μm, equal to or less than 100 μm, equal to or less than 50 μm, or equal to or less than 30 μm. Note that the particle diameter D₅₀ is the particle diameter (median diameter) at an integrated value of 50% in the volume-based particle size distribution determined by the laser diffraction/scattering method.

The material of the negative electrode active material particles is not particularly limited, and may be metal lithium, and may be a material capable of occluding and releasing metal ions such as lithium ions. Examples of the material capable of occluding and releasing metal ions such as lithium ions include, but are not limited to, an alloy-based negative electrode active material, a carbon material, and lithium titanate (Li₄Ti₅O₁₂).

The alloy-based negative electrode active material is not particularly limited, and examples thereof include a Si alloy-based negative electrode active material and a Sn alloy-based negative electrode active material. Si alloy-based negative electrode active material, silicon, silicon oxide, silicon carbide, silicon nitride or the like, or a solid solution thereof. Si alloy-based negative electrode active material may include a metallic element other than silicon, for example, Fe, Co, Sb, Bi, Pb, Ni, Cu, Zn, Ge, In, Sn, Ti or the like. Examples of Sn alloy-based negative electrode active material include tin, tin oxide, tin nitride, and the like, or a solid solution thereof. Sn alloy-based negative electrode active material may include a metallic element other than tin, for example, Fe, Co, Sb, Bi, Pb, Ni, Cu, Zn, Ge, In, Ti, Si or the like.

The carbon material is not particularly limited, and examples thereof include hard carbon, soft carbon, and graphite.

The shape of the negative electrode active material particles is not particularly limited, and may be, for example, a spherical shape, an ellipsoid shape, a flake shape, a fibrous shape, or the like. The particle diameter D₅₀ of the negative electrode active material may be, for example, greater than or equal to 1 nm, greater than or equal to 5 nm, or greater than or equal to 10 nm, and may be less than or equal to 500 μm, less than or equal to 100 μm, less than or equal to 50 μm, or less than or equal to 30 μm. Note that the particle diameter D₅₀ is the particle diameter (median diameter) at an integrated value of 50% in the volume-based particle size distribution determined by the laser diffraction/scattering method.

### Binder

In the present disclosure, the binder is included in the electrode mixture.

Examples of the binder include, but are not limited to, carboxymethylcellulose (CMC), styrene-butadiene rubber (SBR), polyvinylidene fluoride (PVdF), polytetrafluoroethylene (PTFE), polyacrylic acid (PAA), and the like. One binder may be used alone or two or more binders may be used in combination.

The content of the binder in the electrode mixture of the present disclosure is not particularly limited, 0.1% by mass or more, 0.5% by mass or more, 1% by mass or more, 3% by mass or more, or 5% by mass or more, and may be 10% by mass or less, 8% by mass or less, 5% by mass or less, 3% by mass or less, or 1% by mass or less.

### Ethylene Carbonate

In the present disclosure, ethylene carbonate is included in the electrode mixture. When the electrode mixture layer is produced by applying the electrode mixture in a layered manner and rolling, at least a part of the electrode mixture layer is heated by the rolling member, whereby the ethylene carbonate contained in the electrode mixture layer is at least partially melted. Accordingly, friction between the active material particles contained in the electrode mixture layer can be reduced.

The content of ethylene carbonate in the electrode mixture of the present disclosure is not particularly limited, but may be 1% by mass or more, 3% by mass or more, 5% by mass or more, 7% by mass or more, or 10% by mass or more, and may be 20% by mass or less, 17% by mass or less, 15% by mass or less, 10% by mass or less, or 7% by mass or less.

### Process (b)

In the method of the present disclosure for producing an electrode active material sheet, the electrode mixture is then pressed, preferably rolled, with a press member. In the present disclosure, press means rolling film formation.

In the present disclosure, in step (b), the ethylene carbonate is at least partially melted.

FIG. 2 illustrates one embodiment of the present disclosure, but is not limited thereto. The electrode active material sheet 300 can be manufactured by rolling the electrode mixture 100 containing the active material particles 120, the binder 140, and the ethylene carbonate 160 with the press member 200. At this time, the temperature of the press member 200 is equal to or higher than the melting point (36.4° C.) of the ethylene carbonate 160. This allows the ethylene carbonate 160 to be at least partially melted during pressing.

In the present disclosure, step (b) may be performed after the electrode mixture is applied to a substrate or the like.

In the present disclosure, the pressure at the time of pressing is not particularly limited, but may be 0.5 kN/cm or more, 1.0 kN/cm or more, 2.0 kN/cm or more, 5.0 kN/cm or more, or 10.0 kN/cm or more, and may be 100.0 kN/cm or less, 80.0 kN/cm or less, 60.0 kN/cm or less, 40.0 kN/cm or less, 20.0 kN/cm or less, or 15.0 kN/cm or less.

### Press Member

In the present disclosure, the electrode mixture is pressed by a press member.

The material of the press member is not particularly limited, and examples thereof include metal, resin, and the like. The press member may be a press roll, and may press the electrode mixture by rotating the press roll.

The temperature of the press member is not particularly limited. The temperature of the press member may be 10° C. or higher, 20° C. or higher, 30° C. or higher, 40° C. or higher, or 50° C. or higher, and may be 100° C. or lower, 90° C. or lower, 80° C. or lower, 70° C. or lower, 60° C. or lower, or 50° C. or lower. In addition, in the present disclosure, the temperature of the press member may preferably be a temperature equal to or higher than the melting point (36.4° C.) of ethylene carbonate. This allows the ethylene carbonate to be at least partially melted during the pressing.

The present disclosure will be described in more detail with reference to the following examples, but the scope of the present disclosure is not limited by these examples.

### Evaluation of Density of Electrode Active Material Sheet

In Comparative Examples 1 and 2 and Examples 1 to 4, the density of the electrode active material sheet produced was evaluated.

### Comparative Example 1

### Preparation

The following materials were prepared: Positive electrode active material: nickel-cobalt-lithium manganate (NCM) Conductive aids: Carbon nanotubes (CNT) Binder: Polytetrafluoroethylene (PTFE)

### Mixing

The positive electrode active material, the conductive auxiliary agent, and the binder were mixed to obtain an electrode mixture.

### Rolling

An electrode mixture was formed by rolling using a rolling roll as a rolling member, and an electrode active material sheet of Comparative Example 1 was obtained. The conditions of the rolling film formation are as shown in Table 1 below.

### Comparative Example 2

The electrode active material sheet of Comparative Example 2 was obtained in the same manner as in Comparative Example 1, except that the pressure at the time of forming the rolled film was set to 2.0 kN/cm. The conditions of the rolling film formation are as shown in Table 1 below.

### Example 1

The electrode active material sheet of Example 1 was obtained in the same manner as in Comparative Example 1, except that the electrode mixture further contained 6.0% by mass of ethylene carbonate (EC) of the entire electrode mixture. The conditions of the rolling film formation are as shown in Table 1 below.

### Example 2

The electrode active material sheet of Example 2 was obtained in the same manner as in Comparative Example 2, except that the electrode mixture further contained 6.0% by mass of ethylene carbonate of the entire electrode mixture. The conditions of the rolling film formation are as shown in Table 1 below.

### Example 3

An electrode active material sheet of Example 3 was obtained in the same manner as in Example 1, except that the temperature at the time of forming the rolled film was 60° C. The conditions of the rolling film formation are as shown in Table 1 below.

### Example 4

An electrode active material sheet of Example 4 was obtained in the same manner as in Example 1, except that the temperature at the time of forming the rolled film was set to 70° C. The conditions of the rolling film formation are as shown in Table 1 below.

### Evaluation

The densities of the electrode active material sheets in Comparative Examples 1 and 2 and Examples 1 to 4 are as shown in Table 1 below. As a result of the comparison of Comparative Examples 1 and 2 and Examples 1 and 2, the density of the electrode active material sheet after the film formation was increased because the electrode mixture contained ethylene carbonate. Further, according to the comparison of Examples 1, 3, and 4, the density of the electrode active material sheet after the film formation was increased by increasing the temperature of the rolling film formation condition. Therefore, the electrode mixture contains ethylene carbonate, and the friction between the particles can be reduced by rolling while at least partially melting the ethylene carbonate.

TABLE 1

| | | | | Density of |
|---|---|---|---|---|
| | | Rolling film formation conditions | | the electrode |
| | EC | Pres- | Temper- | active mate- |
| | addi- | sure | ature | rial sheet |
| | tion | [kN/cm] | [° C.] | [g/cm\hat{ }3] |
| Comparative | None | 1.0 | 50 | 2.02 |
| Example 1 | | | | |
| Comparative | None | 2.0 | 50 | 2.13 |
| Example 2 | | | | |
| Example 1 | Coated | 1.0 | 50 | 2.11 |
| Example 2 | Coated | 2.0 | 50 | 2.27 |
| Example 3 | Coated | 1.0 | 60 | 2.21 |
| Example 4 | Coated | 1.0 | 70 | 2.22 |

What is claimed is:

1. A method of manufacturing an electrode active material sheet, the method comprising:
providing an electrode mixture comprising active material particles, a binder, and ethylene carbonate; and
pressing the electrode mixture using a press member, wherein the pressing of the electrode mixture using the press member includes at least partially melting the ethylene carbonate.

2. The method according to claim 1, wherein a temperature of the press member is equal to or higher than a melting point of the ethylene carbonate.

3. The method according to claim 1, wherein the binder is polytetrafluoroethylene.

4. The method according to claim 1, wherein the press member is a press roll.
